(19) United States
(12) Patent Application Publication
(10) Pub. No.: US 2025/0328044 A1
(43) Pub. Date: Oct. 23, 2025

(54) CHOLESTERIC LIQUID CRYSTAL DISPLAY DEVICE

(71) Applicant: Iris Optronics Co., Ltd., Tainan City (TW)

(72) Inventors: Chi Chang LIAO, Tainan City (TW); Ching Shan LIN, Kaohsiung City (TW); Hui Che LIN, Tainan City (TW); Jung Chih CHOU, Tainan City (TW)

(21) Appl. No.: 19/185,288

(22) Filed: Apr. 22, 2025

Related U.S. Application Data
(60) Provisional application No. 63/637,564, filed on Apr. 23, 2024.

(30) Foreign Application Priority Data
Apr. 18, 2025 (TW) 114114867

(51) Int. Cl. G02F 1/1335; G02F 1/1343; G02F 1/137

(52) U.S. Cl. CPC G02F 1/133514; G02F 1/134309; G02F 1/137; G02F 2202/28

(57) ABSTRACT

A cholesteric liquid crystal display device includes three multilayer structures, which are stacked on each other. Each of the multilayer structures includes a color substrate, a lower electrode layer, a pixel layer, an upper electrode layer and an upper substrate. The color substrate absorbs or filters a stray light from outside.

### RELATED APPLICATIONS

This application claims priority to U.S. Provisional Application Ser. No. 63/637,564, filed Apr. 23, 2024, and Taiwan Application Serial Number 114114867, filed Apr. 18, 2025, which is herein incorporated by reference.

### BACKGROUND

### Technical Field

The present disclosure relates to a cholesteric liquid crystal display device. More particularly, the present disclosure relates to a cholesteric liquid crystal display device which can reduce reflection of a stray light.

### Description of Related Art

The conventional cholesteric liquid crystal display device displays images by reflecting surrounding light source. The conventional cholesteric liquid crystal display device is mainly formed by stacking a plurality of display modules. In order to adhere the plurality of display modules, each of the display modules is adhered to each other by using optical color adhesives. Although the optical color adhesives can remove unnecessary stray light, the surrounding light source is often reflected by substrates before entering the optical color adhesives. Therefore, the surrounding light source reflected by liquid crystal is not enough, which makes the display quality of the cholesteric liquid crystal display device poor.

In other words, the optical color adhesives in the conventional structures cannot perform its maximum function, because most of the surrounding light source is reflected by the substrates. Therefore, part of the stray light is not removed by the optical color adhesives. In addition, the stacked structures of the cholesteric liquid crystal display device are complicated, so repeated adherence processes are required. It leads to the thickness, weight and production costs of the cholesteric liquid crystal display device remain high.

In view of this, how to reduce the reflection of the stray light, and how to simplify the structure of the cholesteric liquid crystal display device has become the goal of relevant industries.

### SUMMARY

According to one embodiment of the present disclosure, a cholesteric liquid crystal display device includes three multilayer structures stacked on each other. Each of the three multilayer structures includes a color substrate, a lower electrode layer, a pixel layer, an upper electrode layer and an upper substrate. The lower electrode layer is connected to the color substrate. The pixel layer is connected to the lower electrode layer, and the lower electrode layer is located between the color substrate and the pixel layer. The upper electrode layer is connected to the pixel layer, and the pixel layer is located between the lower electrode layer and the upper electrode layer. The upper substrate is connected to the upper electrode layer, and the upper electrode layer is located between the pixel layer and the upper substrate. The color substrate absorbs or filters a stray light from outside.

According to another embodiment of the present disclosure, a cholesteric liquid crystal display device includes three multilayer structures stacked on each other. Each of the three multilayer structures includes a color substrate, a lower electrode layer, a pixel layer and an upper electrode layer. The lower electrode layer is connected to the color substrate. The pixel layer is connected to the lower electrode layer, and the lower electrode layer is located between the color substrate and the pixel layer. The upper electrode layer is connected to the pixel layer, and the pixel layer is located between the lower electrode layer and the upper electrode layer. The color substrate absorbs or filters a stray light from outside.

### BRIEF DESCRIPTION OF THE DRAWINGS

FIG. 1 is a cross-sectional schematic view of a cholesteric liquid crystal display device according to the 1st embodiment of the present disclosure.

FIG. 2 is a cross-sectional schematic view of a cholesteric liquid crystal display device according to the 2nd embodiment of the present disclosure.

FIG. 3 is a cross-sectional schematic view of a cholesteric liquid crystal display device according to the 3rd embodiment of the present disclosure.

FIG. 4 is a cross-sectional schematic view of a cholesteric liquid crystal display device according to the 4th embodiment of the present disclosure.

FIG. 5 is a cross-sectional schematic view of the second color substrate according to FIG. 4 of the present disclosure.

FIG. 6 is a cross-sectional schematic view of a cholesteric liquid crystal display device according to the 5th embodiment of the present disclosure.

FIG. 7 is a cross-sectional schematic view of a cholesteric liquid crystal display device according to the 6th embodiment of the present disclosure.

FIG. 8 is a cross-sectional schematic view of a cholesteric liquid crystal display device according to the 7th embodiment of the present disclosure.

FIG. 9 is a cross-sectional schematic view of a cholesteric liquid crystal display device according to the 8th embodiment of the present disclosure.

### DETAILED DESCRIPTION

A number of examples of the present disclosure will be described below with reference to the accompanying drawings. The following description will include many practical details in order to be clear and specific. The reader, however, should understand that those practical details are not intended to be restrictive of the scope of the invention; in other words, the practical details are not essential to some embodiments of the invention. Besides, for the sake of simplicity of the drawings, some conventional or commonly used structures and elements are drawn only schematically in the drawings, and repeated elements may be indicated by the same reference numeral or similar reference numerals.

The terms first, second, third, etc. are used herein to describe various elements, these elements should not be limited by these terms. Consequently, a first element, component or module discussed below could be termed a second element, component or module. Besides, a combination of these elements of the present disclosure is not a common combination in this art, so it cannot be predicted whether a relation of the combination hereof can be easily done by a person having skill in the art by these elements.

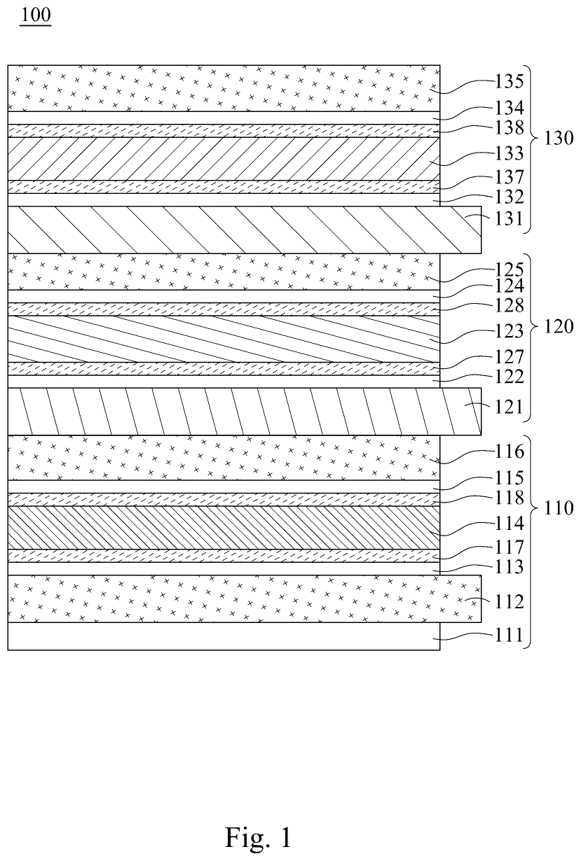

Please refer to FIG. 1. FIG. 1 is a cross-sectional schematic view of a cholesteric liquid crystal display device 100 according to the 1st embodiment of the present disclosure. The cholesteric liquid crystal display device 100 includes a first multilayer structure 110, a second multilayer structure 120 and a third multilayer structure 130.

The first multilayer structure 110 includes a light absorbing layer 111, a first color substrate 112, a first lower electrode layer 113, a first pixel layer 114, a first upper electrode layer 115 and a first upper substrate 116. The first color substrate 112 is connected to the light absorbing layer 111. The first lower electrode layer 113 is connected to the first color substrate 112, and the first color substrate 112 is located between the light absorbing layer 111 and the first lower electrode layer 113. The first pixel layer 114 is connected to the first lower electrode layer 113, and the first lower electrode layer 113 is located between the first color substrate 112 and the first pixel layer 114. The first upper electrode layer 115 is connected to the first pixel layer 114, and the first pixel layer 114 is located between the first lower electrode layer 113 and the first upper electrode layer 115. The first upper substrate 116 is connected to the first upper electrode layer 115, and the first upper electrode layer 115 is located between the first pixel layer 114 and the first upper substrate 116.

The second multilayer structure 120 is connected to the first multilayer structure 110. The second multilayer structure 120 includes a second color substrate 121, a second lower electrode layer 122, a second pixel layer 123, a second upper electrode layer 124 and a second upper substrate 125. The second color substrate 121 is connected to the first upper substrate 116, and the first upper substrate 116 is located between the first upper electrode layer 115 and the second color substrate 121. The second lower electrode layer 122 is connected to the second color substrate 121, and the second color substrate 121 is located between the first upper substrate 116 and the second lower electrode layer 122. The second pixel layer 123 is connected to the second lower electrode layer 122, and the second lower electrode layer 122 is located between the second color substrate 121 and the second pixel layer 123. The second upper electrode layer 124 is connected to the second pixel layer 123, and the second pixel layer 123 is located between the second lower electrode layer 122 and the second upper electrode layer 124. The second upper substrate 125 is connected to the second upper electrode layer 124, and the second upper electrode layer 124 is located between the second pixel layer 123 and the second upper substrate 125.

The third multilayer structure 130 is connected to the second multilayer structure 120. The third multilayer structure 130 includes a third color substrate 131, a third lower electrode layer 132, a third pixel layer 133, a third upper electrode layer 134 and a third upper substrate 135. The third color substrate 131 is connected to the second upper substrate 125, and the second upper substrate 125 is located between the second upper electrode layer 124 and the third color substrate 131. The third lower electrode layer 132 is connected to the third color substrate 131, and the third color substrate 131 is located between the second upper substrate 125 and the third lower electrode layer 132. The third pixel layer 133 is connected to the third lower electrode layer 132, and the third lower electrode layer 132 is located between the third color substrate 131 and the third pixel layer 133. The third upper electrode layer 134 is connected to the third pixel layer 133, and the third pixel layer 133 is located between the third lower electrode layer 132 and the third upper electrode layer 134. The third upper substrate 135 is connected to the third upper electrode layer 134, and the third upper electrode layer 134 is located between the third pixel layer 133 and the third upper substrate 135.

Moreover, the first color substrate 112, the second color substrate 121 and the third color substrate 131 absorb or filter a stray light from outside.

In detail, the first color substrate 112, the second color substrate 121 and the third color substrate 131 can achieve the effect of absorbing or filtering the stray light through photoresist coating, element doping, color dyeing or other processes. However, the present disclosure is not limited thereto.

The light absorbing layer 111 absorbs an incident light source to reduce reflection of the incident light source inside the cholesteric liquid crystal display device 100, so as to improve the display effect of the cholesteric liquid crystal display device 100.

Furthermore, the first lower electrode layer 113, the first upper electrode layer 115, the second lower electrode layer 122, the second upper electrode layer 124, the third lower electrode layer 132 and third upper electrode layer 134 control color rendering effect of the first pixel layer 114, the second pixel layer 123 and the third pixel layer 133 by controlling the flow of current or changing the electric field, so as to control the display effect of the cholesteric liquid crystal display device 100.

By setting the first color substrate 112, the second color substrate 121 and the third color substrate 131 to absorb or filter the stray light from outside, the reflection of the incident light source of the first upper substrate 116 and the second upper substrate 125 can be reduced. Therefore, the reflection of the cholesteric liquid crystal display device 100 can be improved, the good image quality of the cholesteric liquid crystal display device 100 can be achieved, and the good optical contrast property of the cholesteric liquid crystal display device 100 can be achieved. Furthermore, because the first color substrate 112, the second color substrate 121 and the third color substrate 131 effectively absorb or filter the stray light from outside, the stacked structure and the adherence process of the cholesteric liquid crystal display device 100 can be reduced, thereby reducing the thickness, weight and production cost of the cholesteric liquid crystal display device 100.

It is worth noting that the first multilayer structure 110, the second multilayer structure 120 and the third multilayer structure 130 can further includes a lower alignment layer 117, 127, 137 and an upper alignment layer 118, 128, 138, respectively. The lower alignment layers 117, 127, 137 are respectively located between the first lower electrode layer 113 and the first pixel layer 114, between the second lower electrode layer 122 and the second pixel layer 123, and between the third lower electrode layer 132 and the third pixel layer 133. The upper alignment layers 118, 128, 138 are respectively located between the first pixel layer 114 and the first upper electrode layer 115, between the second pixel layer 123 and the second upper electrode layer 124, and between the third pixel layer 133 and the third upper electrode layer 134.

Take the first multilayer structure 110 as example, by the lower alignment layer 117 and the upper alignment layer 118, the color rendering effect of the first pixel layer 114 can be better controlled by controlling the arrangement direction of the liquid crystal of the first pixel layer 114. Thus, by setting the lower alignment layers 117, 127, 137 and the upper alignment layers 118, 128, 138, the display effect of the cholesteric liquid crystal display device 100 can be improved.

Furthermore, the first color substrate 112, the second color substrate 121 and the third color substrate 131 can be, but not limited to, common substrates as the first upper substrate 116, the second upper substrate 125 and the third upper substrate 135. In other words, the cholesteric liquid crystal display device 100 can include one, two or three color substrates as the lower substrates of the multilayer structures. As shown in FIG. 1, the first multilayer structure 110 is the common substrate, and the second multilayer structure 120 and the third multilayer structure 130 are the color substrates, which is the same in the following embodiments. The number of the color substrates can be changed according to the requirements, so as to increase the freedom of application of the cholesteric liquid crystal display device 100. However, the present disclosure is not limited thereto.

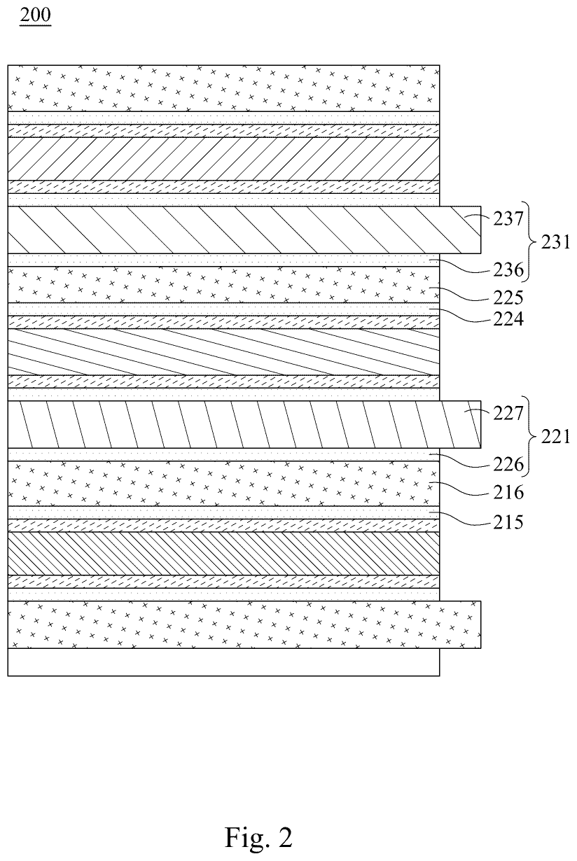

Please refer to FIG. 2. FIG. 2 is a cross-sectional schematic view of a cholesteric liquid crystal display device 200 according to the 2nd embodiment of the present disclosure. Configuration of the cholesteric liquid crystal display device 200 in FIG. 2 is substantially similar to configuration of the cholesteric liquid crystal display device 100 in FIG. 1, and the similarities thereof are not repeated herein.

In particular, the second color substrate 221 can include a second optical clear adhesive layer 226 and a second lower substrate 227. The second optical clear adhesive layer 226 is connected to the first upper substrate 216, and the first upper substrate 216 is located between the first upper electrode layer 215 and the second optical clear adhesive layer 226. The second lower substrate 227 is connected to the second optical clear adhesive layer 226, and the second optical clear adhesive layer 226 is located between the first upper substrate 216 and the second lower substrate 227. The second lower substrate 227 is colored, and the second lower substrate 227 absorbs or filters the stray light from outside.

Furthermore, the third color substrate 231 can include a third optical clear adhesive layer 236 and a third lower substrate 237. The third optical clear adhesive layer 236 is connected to the second upper substrate 225, and the second upper substrate 225 is located between the second upper electrode layer 224 and the third optical clear adhesive layer 236. The third lower substrate 237 is connected to the third optical clear adhesive layer 236, and the third optical clear adhesive layer 236 is located between the second upper substrate 225 and the third lower substrate 237. The third lower substrate 237 is colored, and the third lower substrate 237 absorbs or filters the stray light from outside.

In detail, the second lower substrate 227 and the third lower substrate 237 can be colored by doping with different elements or dyeing with different colors. The second lower substrate 227 and the third lower substrate 237 have the effect of absorbing or filtering the stray light. However, the present disclosure is not limited thereto.

By setting the second lower substrate 227 and the third lower substrate 237 to absorb or filter the stray light from outside, the reflection of the incident light source of the first upper substrate 216 and the second upper substrate 225 can be reduced. Therefore, the reflection of the cholesteric liquid crystal display device 200 can be improved, the good image quality of the cholesteric liquid crystal display device 200 can be achieved, and the good optical contrast property of the cholesteric liquid crystal display device 200 can be achieved. Furthermore, because the second lower substrate 227 and the third lower substrate 237 effectively absorb or filter the stray light from outside, the stacked structure and the adherence process of the cholesteric liquid crystal display device 200 can be reduced, thereby reducing the thickness, weight and production cost of the cholesteric liquid crystal display device 200.

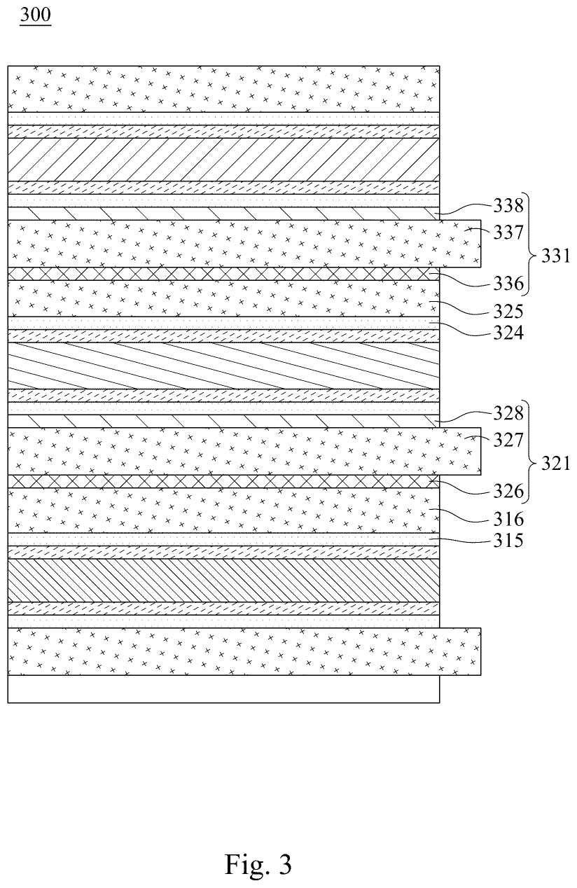

Please refer to FIG. 3. FIG. 3 is a cross-sectional schematic view of a cholesteric liquid crystal display device 300 according to the 3rd embodiment of the present disclosure. Configuration of the cholesteric liquid crystal display device 300 in FIG. 3 is substantially similar to the structural configuration of the cholesteric liquid crystal display device 100 in FIG. 1, and the similarities thereof are not repeated herein.

In particular, the second color substrate 321 can include a second optical clear adhesive layer 326, a second lower substrate 327 and a second color photoresist layer 328. The second optical clear adhesive layer 326 is connected to the first upper substrate 316, and the first upper substrate 316 is located between the first upper electrode layer 315 and the second optical clear adhesive layer 326. The second lower substrate 327 is connected to the second optical clear adhesive layer 326, and the second optical clear adhesive layer 326 is located between the first upper substrate 316 and the second lower substrate 327. The second color photoresist layer 328 is connected to the second lower substrate 327, and the second lower substrate 327 is located between the second optical clear adhesive layer 326 and the second color photoresist layer 328.

The third color substrate 331 can include a third optical clear adhesive layer 336, a third lower substrate 337 and a third color photoresist layer 338. The third optical clear adhesive layer 336 is connected to the second upper substrate 325, and the second upper substrate 325 is located between a second upper electrode layer 324 and the third optical clear adhesive layer 336. The third lower substrate 337 is connected to the third optical clear adhesive layer 336, and the third optical clear adhesive layer 336 is located between the second upper substrate 325 and the third lower substrate 337. The third color photoresist layer 338 is connected to the third lower substrate 337, and the third lower substrate 337 is located between the third optical clear adhesive layer 336 and the third color photoresist layer 338.

In detail, by setting the second color photoresist layer 328 and the third color photoresist layer 338, the reflection of the incident light source of the first upper substrate 316, the second lower substrate 327, the second upper substrate 325 and the third lower substrate 337 can be reduced. Therefore, the reflection of the cholesteric liquid crystal display device 300 can be improved, the good image quality of the cholesteric liquid crystal display device 300 can be achieved, and the good optical contrast property of the cholesteric liquid crystal display device 300 can be achieved. Furthermore, because the second color photoresist layer 328 and the third color photoresist layer 338 effectively absorb or filter the stray light from outside, the stacked structure and the adherence process of the cholesteric liquid crystal display device 300 can be reduced, thereby reducing the thickness, weight and production cost of the cholesteric liquid crystal display device 300.

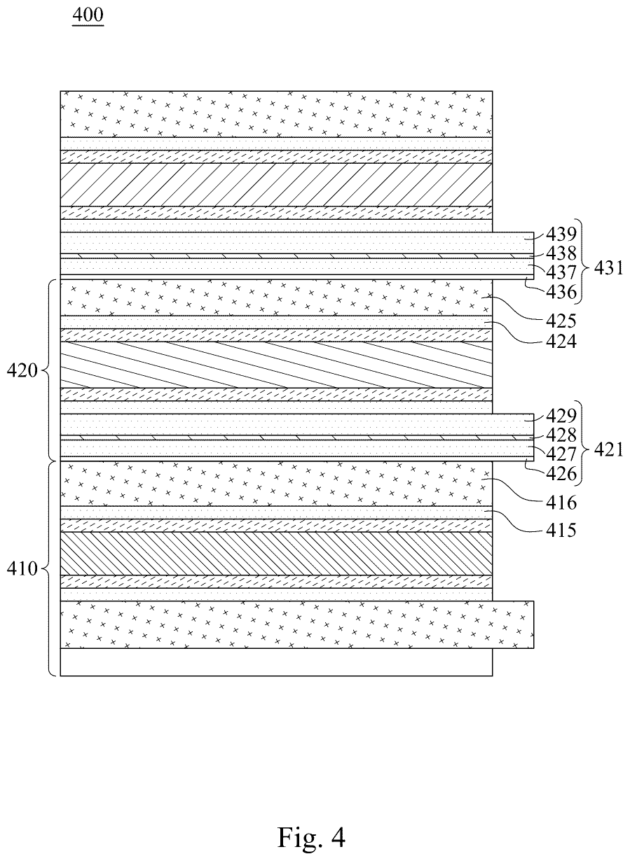

Please refer to FIG. 4. FIG. 4 is a cross-sectional schematic view of a cholesteric liquid crystal display device 400 according to the 4th embodiment of the present disclosure. Configuration of the cholesteric liquid crystal display device 400 in FIG. 4 is substantially similar to configuration of the cholesteric liquid crystal display device 100 in FIG. 1, and the similarities thereof are not repeated herein.

In particular, the second color substrate 421 can include a second optical clear adhesive layer 426, a fourth lower substrate 427, a second optical color adhesive layer 428 and a fourth upper substrate 429. The second optical clear adhesive layer 426 is connected to the first upper substrate 416, and the first upper substrate 416 is located between the first upper electrode layer 415 and the second optical clear adhesive layer 426. The fourth lower substrate 427 is connected to the second optical clear adhesive layer 426, and the second optical clear adhesive layer 426 is located between the first upper substrate 416 and the fourth lower substrate 427. The second optical color adhesive layer 428 is connected to the fourth lower substrate 427, and the fourth lower substrate 427 is located between the second optical clear adhesive layer 426 and the second optical color adhesive layer 428. The fourth upper substrate 429 is connected to the second optical color adhesive layer 428, and the second optical color adhesive layer 428 is located between the fourth lower substrate 427 and the fourth upper substrate 429.

The third color substrate 431 can include a third optical clear adhesive layer 436, a fifth lower substrate 437, a third optical color adhesive layer 438 and a fifth upper substrate 439. The third optical clear adhesive layer 436 is connected to the second upper substrate 425, and the second upper substrate 425 is located between the second upper electrode layer 424 and the third optical clear adhesive layer 436. The fifth lower substrate 437 is connected to the third optical clear adhesive layer 436, and the third optical clear adhesive layer 436 is located between the second upper substrate 425 and the fifth lower substrate 437. The third optical color adhesive layer 438 is connected to the fifth lower substrate 437, and the fifth lower substrate 437 is located between the third optical clear adhesive layer 436 and the third optical color adhesive layer 438. The fifth upper substrate 439 is connected to the third optical color adhesive layer 438, and the third optical color adhesive layer 438 is located between the fifth lower substrate 437 and the fifth upper substrate 439.

By setting the second optical color adhesive layer 428 and the third optical color adhesive layer 438, the stray light entering the first multilayer structure 410 and the second multilayer structure 420 can be reduced. Therefore, the reflection of the cholesteric liquid crystal display device 400 can be improved, the good image quality of the cholesteric liquid crystal display device 400 can be achieved, and the good optical contrast property of the cholesteric liquid crystal display device 400 can be achieved. Furthermore, because the second optical color adhesive layer 428 and the third optical color adhesive layer 438 effectively absorb or filter the stray light from outside, the stacked structure and the adherence process of the cholesteric liquid crystal display device 400 can be reduced, thereby reducing the thickness, weight and production cost of the cholesteric liquid crystal display device 400.

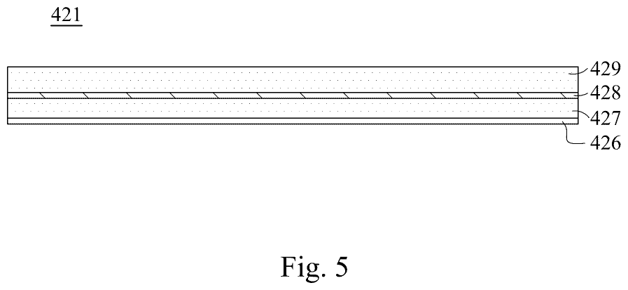

Please refer to FIG. 4 and FIG. 5. FIG. 5 is a cross-sectional schematic view of the second color substrate 421 according to FIG. 4 of the present disclosure. During fabrication of the cholesteric liquid crystal display device 400, the second color substrate 421 can be prepared first, and then the second color substrate 421 can be assembled with other structural layers. In detail, the second color substrate 421 can be formed through the adherence processes among the second optical clear adhesive layer 426, the fourth lower substrate 427, the second optical color adhesive layer 428, and the fourth upper substrate 429, so as to achieve the following advantages. First, the alignment accuracy and the optical characteristics can be improved. Second, the difficulty of adherence in the product can be reduced, thereby improving the yield rate of the final product. Third, the second color substrate 421 is applicable to plastic substrates (not shown), and the flexibility of the cholesteric liquid crystal display device 400 can be enhanced. It should be noted that the above advantages are also applicable to the third color substrate 431.

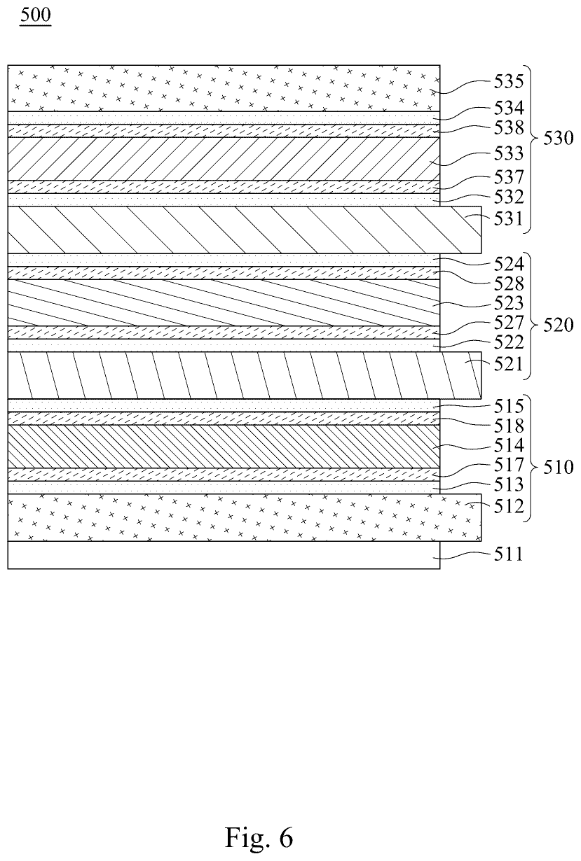

Please refer to FIG. 6. FIG. 6 is a cross-sectional schematic view of a cholesteric liquid crystal display device 500 according to the 5th embodiment of the present disclosure. The cholesteric liquid crystal display device 500 includes a first multilayer structure 510, a second multilayer structure 520 and a third multilayer structure 530.

The first multilayer structure 510 includes a light absorbing layer 511, a first color substrate 512, a first lower electrode layer 513, a first pixel layer 514 and a first upper electrode layer 515. The first color substrate 512 is connected to the light absorbing layer 511. The first lower electrode layer 513 is connected to the first color substrate 512, and the first color substrate 512 is located between the light absorbing layer 511 and the first lower electrode layer 513. The first pixel layer 514 is connected to the first lower electrode layer 513, and the first lower electrode layer 513 is located between the first color substrate 512 and the first pixel layer 514. The first upper electrode layer 515 is connected to the first pixel layer 514, and the first pixel layer 514 is located between the first lower electrode layer 513 and the first upper electrode layer 515.

The second multilayer structure 520 is connected to the first multilayer structure 510. The second multilayer structure 520 includes a second color substrate 521, a second lower electrode layer 522, a second pixel layer 523 and a second upper electrode layer 524. The second color substrate 521 is connected to the first upper electrode layer 515, and the first upper electrode layer 515 is located between the first pixel layer 514 and the second color substrate 521. The second lower electrode layer 522 is connected to the second color substrate 521, and the second color substrate 521 is located between the first upper electrode layer 515 and the second lower electrode layer 522. The second pixel layer 523 is connected to the second lower electrode layer 522, and the second lower electrode layer 522 is located between the second color substrate 521 and the second pixel layer 523. The second upper electrode layer 524 is connected to the second pixel layer 523, and the second pixel layer 523 is located between the second lower electrode layer 522 and the second upper electrode layer 524.

The third multilayer structure 530 is connected to the second multilayer structure 520. The third multilayer structure 530 includes a third color substrate 531, a third lower electrode layer 532, a third pixel layer 533, a third upper electrode layer 534 and a first upper substrate 535. The third color substrate 531 is connected to the second upper electrode layer 524, and the second upper electrode layer 524 is located between the second pixel layer 523 and the third color substrate 531. The third lower electrode layer 532 is connected to the third color substrate 531, and the third color substrate 531 is located between the second upper electrode layer 524 and the third lower electrode layer 532. The third pixel layer 533 is connected to the third lower electrode layer 532, and the third lower electrode layer 532 is located between the third color substrate 531 and the third pixel layer 533. The third upper electrode layer 534 is connected to the third pixel layer 533, and the third pixel layer 533 is located between the third lower electrode layer 532 and the third upper electrode layer 534. The first upper substrate 535 is connected to the third upper electrode layer 534, and the third upper electrode layer 534 is located between the third pixel layer 533 and the first upper substrate 535.

Moreover, the first color substrate 512, the second color substrate 521 and the third color substrate 531 absorb or filter a stray light from outside.

In addition, the difference between the 5th embodiment and the cholesteric liquid crystal display device 100 in FIG. 1 is that the first multilayer structure 510 and the second multilayer structure 520 share the second color substrate 521, while the second multilayer structure 520 and the third multilayer structure 530 share the third color substrate 531. Thus, a double-sided process is adopted to respectively form the second lower electrode layer 522 and the first upper electrode layer 515 on lower and upper surfaces of the second color substrate 521. Likewise, the double-sided process is also adopted to respectively form the third lower electrode layer 532 and the second upper electrode layer 524 on lower and upper surfaces of the third color substrate 531. Therefore, the adherence processes and steps as well as the usage of substrates can be reduced, thereby reducing the thickness of the cholesteric liquid crystal display device 500.

In detail, the second color substrate 521 and the third color substrate 531 can achieve the effect of absorbing or filtering the stray light through photoresist coating, element doping, color dyeing or other processes. However, the present disclosure is not limited thereto.

The light absorbing layer 511 absorbs an incident light source to reduce reflection of the incident light source inside the cholesteric liquid crystal display device 500, so as to improve the display effect of the cholesteric liquid crystal display device 500.

Furthermore, the first lower electrode layer 513, the first upper electrode layer 515, the second lower electrode layer 522, the second upper electrode layer 524, the third lower electrode layer 532 and third upper electrode layer 534 control color rendering effect of the first pixel layer 514, the second pixel layer 523 and the third pixel layer 533 by controlling the flow of current or changing the electric field, so as to control the display effect of the cholesteric liquid crystal display device 500.

By setting the second color substrate 521 and the third color substrate 531 to absorb or filter the stray light from outside, the reflection of the cholesteric liquid crystal display device 500 can be improved, the good image quality of the cholesteric liquid crystal display device 500 can be achieved, and the good optical contrast property of the cholesteric liquid crystal display device 500 can be achieved. Furthermore, because the second color substrate 521 and the third color substrate 531 effectively absorb or filter the stray light from outside, the stacked structure and the adherence process of the cholesteric liquid crystal display device 500 can be reduced, thereby reducing the thickness, weight and production cost of the cholesteric liquid crystal display device 500.

It is worth noting that the first multilayer structure 510, the second multilayer structure 520 and the third multilayer structure 530 can further includes a lower alignment layer 517, 527, 537 and an upper alignment layer 518, 528, 538, respectively. The lower alignment layers 517, 527, 537 are respectively located between the first lower electrode layer 513 and the first pixel layer 514, between the second lower electrode layer 522 and the second pixel layer 523, and between the third lower electrode layer 532 and the third pixel layer 533. The upper alignment layers 518, 528, 538 are respectively located between the first pixel layer 514 and the first upper electrode layer 515, between the second pixel layer 523 and the second upper electrode layer 524, and between the third pixel layer 533 and the third upper electrode layer 534.

Take the first multilayer structure 510 as example, by the lower alignment layer 517 and the upper alignment layer 518, the color rendering effect of the first pixel layer 514 can be better controlled by controlling the arrangement direction of the liquid crystal of the first pixel layer 514. Thus, by setting the lower alignment layers 517, 527, 537 and the upper alignment layers 518, 528, 538, the display effect of the cholesteric liquid crystal display device 500 can be improved.

As FIG. 6 shown, the cholesteric liquid crystal display device 500 can include one, two or three color substrates as the lower substrates of the multilayer structures. However, in the 5th embodiment, the first multilayer structure 510 is the common substrate, and the second multilayer structure 520 and the third multilayer structure 530 are the color substrates, which is the same in the following embodiments. The number of the color substrates can be changed according to the requirements, so as to increase the freedom of application of the cholesteric liquid crystal display device 500. However, the present disclosure is not limited thereto.

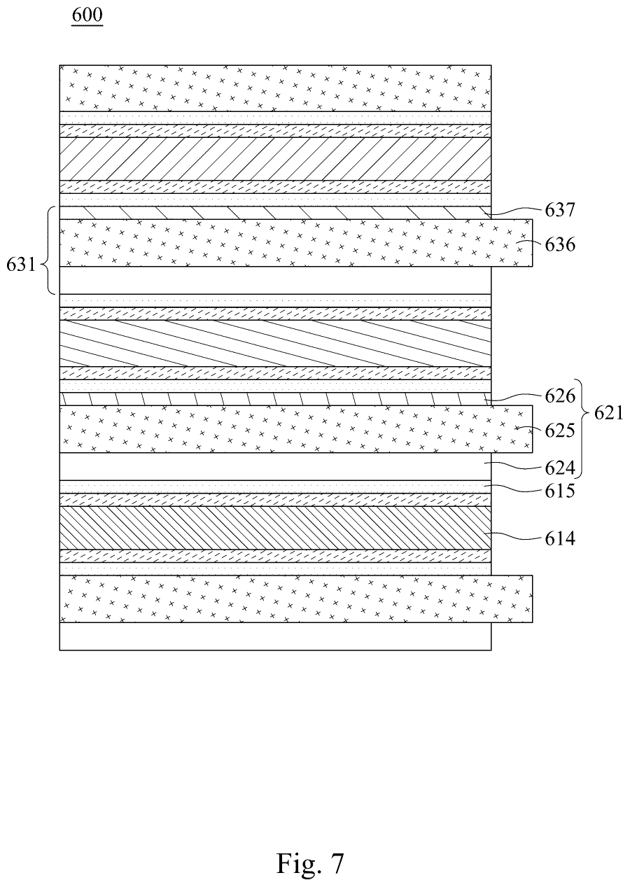

Please refer to FIG. 7. FIG. 7 is a cross-sectional schematic view of a cholesteric liquid crystal display device 600 according to the 6th embodiment of the present disclosure. Configuration of the cholesteric liquid crystal display device 600 in FIG. 7 is substantially similar to configuration of the cholesteric liquid crystal display device 500 in FIG. 6, and the similarities thereof are not repeated herein.

In particular, the second color substrate 621 can include a second optical clear adhesive layer 624, a second lower substrate 625 and a second color photoresist layer 626. The second optical clear adhesive layer 624 is connected to the first upper electrode layer 615, and the first upper electrode layer 615 is located between the first pixel layer 614 and the second optical clear adhesive layer 624. The second lower substrate 625 is connected to the second optical clear adhesive layer 624, and the second optical clear adhesive layer 624 is located between the first upper electrode layer 615 and the second lower substrate 625. The second color photoresist layer 626 is connected to the second lower substrate 625, and the second lower substrate 625 is located between the second optical clear adhesive layer 624 and the second color photoresist layer 626. Besides, the same goes for the third color substrate 631.

In detail, by setting the second color photoresist layer 626 and the third color photoresist layer 637, the reflection of the incident light source of the second lower substrate 625 and the third lower substrate 636 can be reduced. Therefore, the reflection of the cholesteric liquid crystal display device 600 can be improved, the good image quality of the cholesteric liquid crystal display device 600 can be achieved, and the good optical contrast property of the cholesteric liquid crystal display device 600 can be achieved. Furthermore, because the second color photoresist layer 626 and the third color photoresist layer 637 effectively absorb or filter the stray light from outside, the stacked structure and the adherence process of the cholesteric liquid crystal display device 600 can be reduced, thereby reducing the thickness, weight and production cost of the cholesteric liquid crystal display device 600.

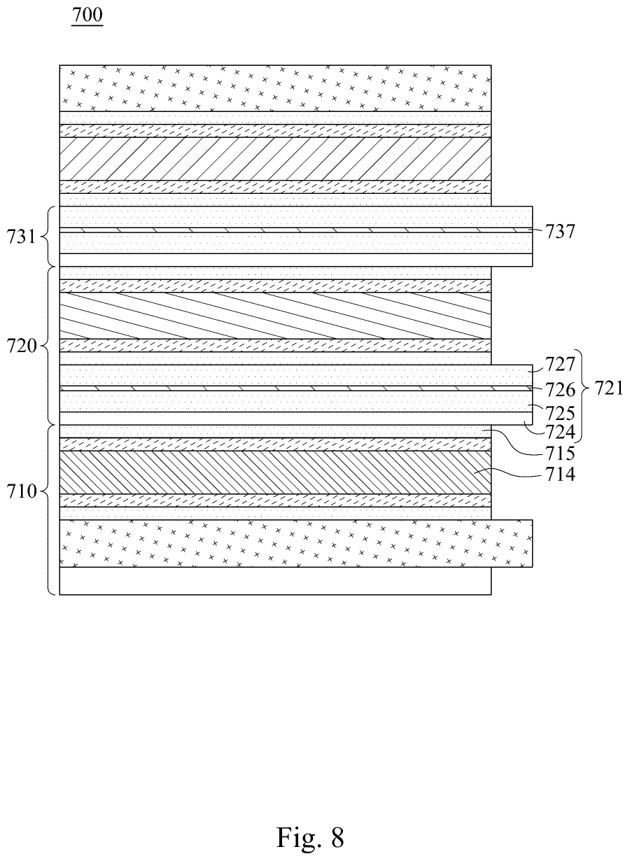

Please refer to FIG. 8. FIG. 8 is a cross-sectional schematic view of a cholesteric liquid crystal display device 700 according to the 7th embodiment of the present disclosure. Configuration of the cholesteric liquid crystal display device 700 in FIG. 8 is substantially similar to configuration of the cholesteric liquid crystal display device 500 in FIG. 6, and the similarities thereof are not repeated herein.

In particular, the second color substrate 721 can include a second optical clear adhesive layer 724, a second lower substrate 725, a second optical color adhesive layer 726 and a second upper substrate 727. The second optical clear adhesive layer 724 is connected to the first upper electrode layer 715, and the first upper electrode layer 715 is located between the first pixel layer 714 and the second optical clear adhesive layer 724. The second lower substrate 725 is connected to the second optical clear adhesive layer 724, and the second optical clear adhesive layer 724 is located between the first upper electrode layer 715 and the second lower substrate 725. The second optical color adhesive layer 726 is connected to the second lower substrate 725, and the second lower substrate 725 is located between the second optical clear adhesive layer 724 and the second optical color adhesive layer 726. The second upper substrate 727 is connected to the second optical color adhesive layer 726, and the second optical color adhesive layer 726 is located between the second lower substrate 725 and the second upper substrate 727. Besides, the same goes for the third color substrate 731.

By setting the second optical color adhesive layer 726 and a third optical color adhesive layer 737, the stray light entering the first multilayer structure 710 and the second multilayer structure 720 can be reduced. Therefore, the reflection of the cholesteric liquid crystal display device 700 can be improved, the good image quality of the cholesteric liquid crystal display device 700 can be achieved, and the good optical contrast property of the cholesteric liquid crystal display device 700 can be achieved. Furthermore, by setting the second optical color adhesive layer 726 and the third optical color adhesive layer 737, the adherence process of the cholesteric liquid crystal display device 700 can be reduced, thereby reducing the thickness, weight and production cost of the cholesteric liquid crystal display device 700.

During fabrication of the cholesteric liquid crystal display device 700, the second color substrate 721 can be prepared first, and then the second color substrate 721 can be assembled with other structural layers. In detail, the second color substrate 721 can be formed through the adherence processes among the second optical clear adhesive layer 724, the second lower substrate 725, the second optical color adhesive layer 726, and the second upper substrate 727, so as to achieve the following advantages. First, the alignment accuracy and the optical characteristics can be improved. Second, the difficulty of adherence in the product can be reduced, thereby improving the yield rate of the final product. Third, the second color substrate 721 is applicable to plastic substrates (not shown), and the flexibility of the cholesteric liquid crystal display device 700 can be enhanced. It should be noted that the above advantages are also applicable to the third color substrate 731.

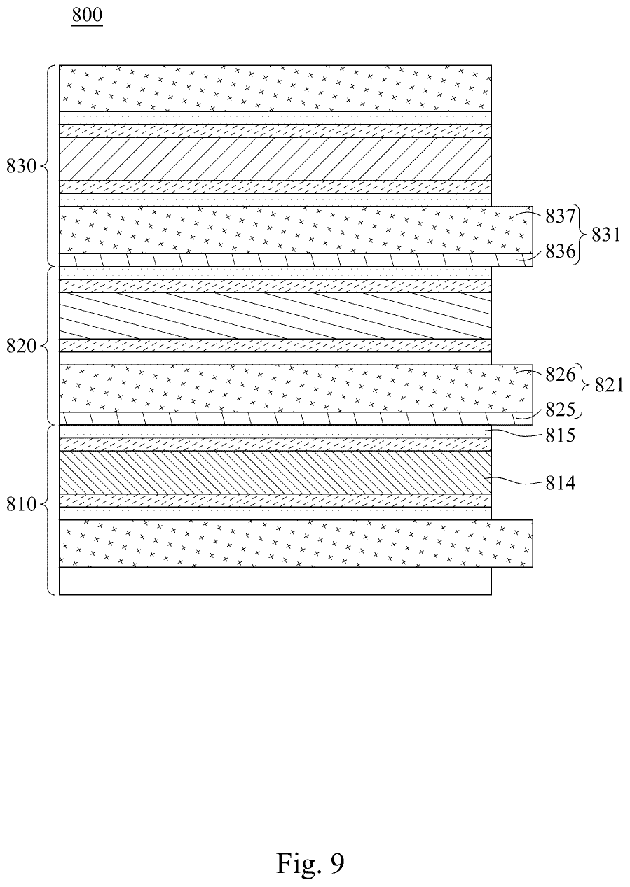

Please refer to FIG. 9. FIG. 9 is a cross-sectional schematic view of a cholesteric liquid crystal display device 800 according to the 8th embodiment of the present disclosure. Configuration of the cholesteric liquid crystal display device 800 in FIG. 9 is substantially similar to configuration of the cholesteric liquid crystal display device 500 in FIG. 6, and the similarities thereof are not repeated herein.

In particular, the second color substrate 821 can include a second optical clear adhesive layer 825 and a second lower substrate 826. The second optical clear adhesive layer 825 is connected to the first upper electrode layer 815, and the first upper electrode layer 815 is located between the first pixel layer 814 and the second optical clear adhesive layer 825. The second lower substrate 826 is connected to the second optical clear adhesive layer 825, and the second optical clear adhesive layer 825 is located between the first upper electrode layer 815 and the second lower substrate 826. Besides, the same goes for the third color substrate 831.

Furthermore, the second lower substrate 826 and the third lower substrate 837 are colored, and the second lower substrate 826 and the third lower substrate 837 absorb or filter the stray light from outside.

In detail, by setting the second optical clear adhesive layer 825 and the third optical clear adhesive layer 836, the difficulty of adherence between the first multilayer structure 810, the second multilayer structure 820 and the third multilayer structure 830 can be reduced, and the stability between the first multilayer structure 810, the second multilayer structure 820 and the third multilayer structure 830 can be enhanced.

In conclusion, in the cholesteric liquid crystal display device of the present disclosure, by setting the color substrate to absorb or filter the stray light from outside, the reflection of the incident light source from the substrates can be reduced. Therefore, the reflection of the cholesteric liquid crystal display device can be improved, the good image quality of the cholesteric liquid crystal display device can be achieved, and the good optical contrast property of the cholesteric liquid crystal display device can be achieved. Furthermore, because the color substrate effectively absorb or filter the stray light from outside, the stacked structure and the adherence process of the cholesteric liquid crystal display device can be reduced, thereby reducing the thickness, weight and production cost of the cholesteric liquid crystal display device.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A cholesteric liquid crystal display device, comprising three multilayer structures stacked on each other, wherein each of the three multilayer structures comprises:
a color substrate;
a lower electrode layer connected to the color substrate;
a pixel layer connected to the lower electrode layer, wherein the lower electrode layer is located between the color substrate and the pixel layer;
an upper electrode layer connected to the pixel layer, wherein the pixel layer is located between the lower electrode layer and the upper electrode layer; and
an upper substrate connected to the upper electrode layer, wherein the upper electrode layer is located between the pixel layer and the upper substrate;
wherein the color substrate absorbs or filters a stray light from outside.

2. The cholesteric liquid crystal display device of claim 1, wherein a lower surface of the color substrate of one of the three multilayer structures stacked at a bottom layer of the cholesteric liquid crystal display device is connected to a light absorbing layer.

3. The cholesteric liquid crystal display device of claim 1, wherein the two color substrates of two of the three multilayer structures stacked at a top layer and a middle layer of the cholesteric liquid crystal display device respectively comprises:
an optical clear adhesive layer connected to the upper substrate of an adjacent one of the three multilayer structures, wherein the upper substrate of the adjacent one of the three multilayer structures is located between the upper electrode layer of the adjacent one of the three multilayer structures and the optical clear adhesive layer; and
a first substrate connected to the optical clear adhesive layer, wherein the optical clear adhesive layer is located between the upper substrate of the adjacent one of the three multilayer structures and the first substrate;
wherein the first substrate is colored, and the first substrate absorbs or filters the stray light from outside.

4. The cholesteric liquid crystal display device of claim 1, wherein the two color substrates of two of the three multilayer structures stacked at a top layer and a middle layer of the cholesteric liquid crystal display device respectively comprises:
an optical clear adhesive layer connected to the upper substrate of an adjacent one of the three multilayer structures, wherein the upper substrate of the adjacent one of the three multilayer structures is located between the upper electrode layer of the adjacent one of the three multilayer structures and the optical clear adhesive layer;
a first substrate connected to the optical clear adhesive layer, wherein the optical clear adhesive layer is located between the upper substrate of the adjacent one of the three multilayer structures and the first substrate; and
a color photoresist layer connected to the first substrate, wherein the first substrate is located between the optical clear adhesive layer and the color photoresist layer.

5. The cholesteric liquid crystal display device of claim 1, wherein the two color substrates of two of the three multilayer structures stacked at a top layer and a middle layer of the cholesteric liquid crystal display device respectively comprises:
an optical clear adhesive layer connected to the upper substrate of an adjacent one of the three multilayer structures, wherein the upper substrate of the adjacent one of the three multilayer structures is located between the upper electrode layer of the adjacent one of the three multilayer structures and the optical clear adhesive layer;
a first substrate connected to the optical clear adhesive layer, wherein the optical clear adhesive layer is located between the upper substrate of the adjacent one of the three multilayer structures and the first substrate;
an optical color adhesive layer connected to the first substrate, wherein the first substrate is located between the optical clear adhesive layer and the optical color adhesive layer; and
a second substrate connected to the optical color adhesive layer, wherein the optical color adhesive layer is located between the first substrate and the second substrate.

6. A cholesteric liquid crystal display device, comprising three multilayer structures stacked on each other, wherein each of the three multilayer structures comprises:
a color substrate;
a lower electrode layer connected to the color substrate;
a pixel layer connected to the lower electrode layer, wherein the lower electrode layer is located between the color substrate and the pixel layer; and
an upper electrode layer connected to the pixel layer, wherein the pixel layer is located between the lower electrode layer and the upper electrode layer;
wherein the color substrate absorbs or filters a stray light from outside.

7. The cholesteric liquid crystal display device of claim 6, further comprising a light absorbing layer, wherein the light absorbing layer is disposed at a lower surface of the color substrate of one of the three multilayer structures stacked at a bottom layer of the cholesteric liquid crystal display device.

8. The cholesteric liquid crystal display device of claim 6, further comprising an upper substrate, wherein the upper substrate is disposed at an upper surface of the upper electrode layer of one of the three multilayer structures stacked at a top layer of the cholesteric liquid crystal display device.

9. The cholesteric liquid crystal display device of claim 6, wherein the two color substrates of two of the three multilayer structures stacked at a top layer and a middle layer of the cholesteric liquid crystal display device respectively comprises:
an optical clear adhesive layer connected to the upper electrode layer of an adjacent one of the three multilayer structures, wherein the upper electrode layer of the adjacent one of the three multilayer structures is located between the pixel layer of the adjacent one of the three multilayer structures and the optical clear adhesive layer; and
a first substrate connected to the optical clear adhesive layer, wherein the optical clear adhesive layer is located between the upper electrode layer of the adjacent one of the three multilayer structures and the first substrate;
wherein the first substrate is colored, and the first substrate absorbs or filters the stray light from outside.

10. The cholesteric liquid crystal display device of claim 6, wherein the two color substrates of two of the three multilayer structures stacked at a top layer and a middle layer of the cholesteric liquid crystal display device respectively comprises:
a first substrate connected to the upper electrode layer of an adjacent one of the three multilayer structures, wherein the upper electrode layer of the adjacent one of the three multilayer structures is located between the pixel layer of the adjacent one of the three multilayer structures and the first substrate; and
a color photoresist layer connected to the first substrate, wherein the first substrate is located between the upper electrode layer of the adjacent one of the three multilayer structures and the color photoresist layer.

11. The cholesteric liquid crystal display device of claim 6, wherein the two color substrates of two of the three multilayer structures stacked at a top layer and a middle layer of the cholesteric liquid crystal display device respectively comprises:
a first substrate connected to the upper electrode layer of an adjacent one of the three multilayer structures, wherein the upper electrode layer of the adjacent one of the three multilayer structures is located between the pixel layer of the adjacent one of the three multilayer structures and the first substrate;
an optical color adhesive layer connected to the first substrate, wherein the first substrate is located between the upper electrode layer of the adjacent one of the three multilayer structures and the optical color adhesive layer; and
a second substrate connected to the optical color adhesive layer, wherein the optical color adhesive layer is located between the first substrate and the second substrate.
